(19) United States
(12) Patent Application Publication
(10) Pub. No.: US 2003/0225621 A1
(43) Pub. Date: Dec. 4, 2003

(54) System, apparatus and method for advertising through product or service previews

(76) Inventors: Hadi Nurcahya, Sugar Land, TX (US); Latham Alan Meier, Bay City, TX (US); Sean Parks, Houston, TX (US)

Correspondence Address: Attention: Jeffrey S. Whittle, Bracewell & Patterson, L.L.P., P.O. Box 61389, Houston, TX, 77208-1389, US

(21) Appl. No.: 10/417,792

(22) Filed: Apr. 17, 2003

Related U.S. Application Data
(60) Provisional application No. 60/375,221, filed on Apr. 17, 2002.

(51) Int. Cl. G06F 17/60

(52) U.S. Cl. 705/14

(57) ABSTRACT

A system having a plurality of portable data terminals positioned at a plurality of separate consumer site visiting locations and an apparatus and methods of advertising are provided. Each of the plurality of portable data terminals preferably has a display associated therewith. Each consumer site visiting location preferably has one or more of the plurality of portable data terminals. Each of the plurality of portable data terminals is preferably networked through a data communication path to a remote computer having advertising software stored in memory of or associated with the computer and defining an advertising server. The advertising server advantageously allows selected product or service previews such as sneak previews of new movie releases, new or existing video game releases, new or existing sportswear, new or existing food products, new or existing beverages, new or existing equipment, and new or existing services.

### RELATED APPLICATIONS

This is a non-provisional patent application, which claims the priority of provisional patent application U.S. Ser. No. 60/375,221, filed Apr. 17, 2002, and titled “Apparatus And Methods For Advertising Through Product Or Service Previews” which is incorporated herein by reference in its entirety.

### 1. FIELD OF THE INVENTION

The present invention relates to the advertising industry and, more particularly, to the field of portable advertising products and methods.

### BACKGROUND OF THE INVENTION

The advertising industry has gone to great lengths to reach targeted customers for selected advertisements over the years. Consumers and potential purchasers can now see advertisements on gasoline pumps and pump handles at gas stations, on various sports stadium signage, on turnstiles accessing various venues, on airport and physician office television or terminals, and on various television, radio, and Internet media. To reach selected consumers with selected advertisements nationally, however, can be quite expensive. For example, it can cost hundreds of thousands or millions of dollars to launch sneak preview campaigns for movies, video games, or various products and services. It can also be quite expensive to attempt to change, update, or enhance an existing advertisement or image of a product or a service. Often, this process can also be time consuming and provides little or no feedback to companies on the success of a mass marketing campaign. This is especially true for companies that engage in mass marketing efforts.

### SUMMARY OF THE INVENTION

With the foregoing in mind, embodiments of a system, an apparatus and methods of the present invention advantageously provide advertisers the opportunity to advertise to consumers of products or services in locations where the consumer is outside the home and in a store or other location previewing products or services of a company. In other words, the advertisement is not through a television network to homes of consumers. Embodiments of the present invention also advantageously provide a system, an apparatus, software and methods for advertising to a captive audience during preview of products or services when and where such products or services often do not reach the consumer. Embodiments of the present invention additionally provide a system, software, and methods for networking advertisements to have the ability to change and target advertisements at desired locations.

More specifically, the present invention provides an apparatus having a plurality of portable data terminals positioned at a plurality of separate consumer site visiting locations, e.g., grocery stores, bookstores, sports stadiums, entertainment venues, theme parks, convenience stores, service or gas stations, or restaurants, and each of the plurality of portable data terminals preferably has a display associated therewith to display advertisements to be previewed by users thereof viewing the display. A data communications network is positioned in communication with each of the plurality of portable data terminals. Each of the plurality of portable data terminals is preferably networked through the data communication line, e.g., wireless, hard-wire, to a remote computer having advertising software stored in memory of or associated with the computer and defining an advertising server. The advertising server advantageously allows selected product or service previews such as sneak previews of new movie releases, new or existing video game releases, new or existing sportswear, new or existing food products, new or existing beverages, new or existing equipment, and new or existing services, e.g., eye care, dental, medical, tax preparation services, or the like. The advertising server allows controlled advertising on the network of the plurality of portable data terminals such as through the display or user interface by having the advertising software select, launch, and initiate the advertisements at all or selected ones of the plurality of portable data terminals.

Each of the plurality of portable data terminals can include a flat panel display, e.g., a liquid crystal display, a portable computer or other remote computer device such as a personal digital assistant (“PDA”) or cellular telephone in communication with the display and including data communication input and output interfaces, an operating system, a modem associated with the portable computer for modulating and demodulating data communication to the portable computer, and administrative software stored on the portable computer to control the portable computer operations with the operating system, to provide reporting capabilities, and to control advertisement changes. The apparatus also preferably has a communications network, e.g., a global communication network such as the Internet, associated with each of the plurality of portable data terminals and the server so that advertisement content can be transferred and updated wirelessly or provided in real time through a secured Internet access from the server to each terminal.

The advertisements on each of the plurality of portable data terminals can then advantageously be controlled by the advertising server and allow advertisers to reach large audiences without the expense of a separate national advertising campaign. Advertisements using embodiments of the present invention can then be targeted for selected audiences during selected time periods chosen by the advertiser to have maximum impact. Also, the present invention can advantageously reward user feedback on the advertisements or previews with gifts, coupons, or other incentives.

An embodiment of the present invention can advantageously provide advertising software on a storage medium, such as a compact disc, memory of a computer, or a magnetic medium, to advertise remotely to users of a data terminal. The advertising software includes an advertisement selector positioned to select at least one of a plurality of different advertisements to be remotely viewed by users when displayed remotely, an advertisement controller in communication with the advertisement selector to control each of the plurality of different advertisements selected by the advertising selector when displayed remotely to a display of a plurality of portable data terminals to users previewing advertisements, an advertisement administrator in communication with the advertisement controller to administer preselected advertisement program commands of an advertiser to the advertisement controller for display to and interface with users when previewing advertisements on the display of each of the plurality of portable data terminals, and an advertisement reporter in communication with the advertisement controller to report advertisement data to an advertiser responsive to or based on results obtained when previewing advertisements by users.

Embodiments of the present invention also provide methods of advertising. A method of advertising, for example, includes selecting at least one of a plurality of different advertisements to be remotely reviewed by users, remotely displaying the at least one of the plurality of different advertisements to a display of a plurality of portable data terminals, controlling the at least one of the plurality of different advertisements displayed remotely to the display of the plurality of portable data terminals to users previewing advertisements, administering preselected advertisement program commands of an advertiser for display to and interface with users when previewing advertisements on the display of each of the plurality of portable data terminals, and reporting advertisement data to an advertiser based on results obtained when previewing advertisements by the users.

The present invention also provides embodiments of methods of doing business. A method of doing business, for example, includes selecting an advertisement of a product or service at a first location, transmitting the advertisement to a remote customer site of a second location through a global communications network, advertising the advertisement through to a user interface at a customer site location to a user, recording user feedback data on the advertisement from the user, and transmitting the user feedback data to the first location through the global communications network. Another method of doing business includes directly targeting customers of a selected advertisement previews from an advertising server through a plurality of portable data terminals positioned at a customer site location remote from the advertising server, running the selected advertisement preview for a preselected time period on the plurality of portable data terminals, receiving user feedback on the selected advertisement at the plurality of portable data terminals, and rewarding the user at the customer site location through the plurality of portable data terminal responsive to the user feedback.

By providing direct target advertisements to consumers or users away from their home, opportunities advantageously are created for supplying low cost feedback to advertisers on the effectiveness of advertisements prior to launching a national campaign or prior to introducing products. This feedback, for example, can be in near real time or real time as desired. This allows advertisers to adjust, change, withdrawal, and improve concepts destined for consumers both in products or services as well as the advertisements themselves. Embodiments of the present invention also allow advertisers to add feedback results to future advertisements and affirm other consumers decision to buy a product or service based on feedback from others.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a schematic block diagram of a system for advertising through product or service previews according to an embodiment of the present invention;

FIG. 2 is a perspective view of a plurality of portable data terminals for advertising through product or service previews according to an embodiment of a system of the present invention;

FIG. 3 is a schematic block diagram of an embodiment of a portable data terminal for advertising through product or service previews according to an embodiment of a system of the present invention;

FIG. 4 is a flow diagram of using a system for advertising through product or service previews according to an embodiment of the present invention;

FIG. 5 is a schematic block diagram of an embodiment of an advertising server having advertising software stored thereon and an advertiser computer positioned remote from the advertising server according to an embodiment of a system of the present invention.

### DETAILED DESCRIPTION

The present invention now will be described more fully hereinafter with reference to the accompanying drawings in which a preferred embodiment of the invention is shown. This invention may, however, be embodied in many different forms and should not be construed as limited to the embodiment set forth herein; rather, this embodiment is provided so that this disclosure will be thorough and complete, and will fully convey the scope of the invention to those skilled in the art. Like numbers refer to like elements throughout.

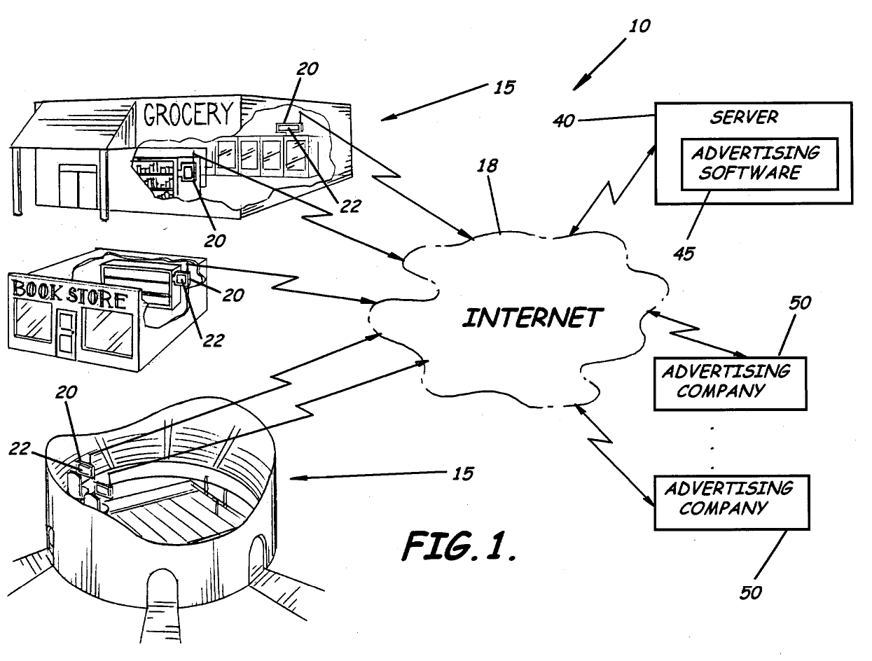

As shown in FIG. 1, an embodiment of the present invention provides a system 10 having a plurality of portable data terminals (“PDTs”) 20 positioned at a plurality of separate consumer site visiting locations 15, e.g., grocery stores, bookstores, sports stadiums, entertainment venues, theme parks, convenience stores, service or gas stations, or restaurants, and each of the plurality of portable data terminals 20 preferably has a display 22 associated therewith. Each consumer site visiting location preferably has one or more of the plurality of portable data terminals 20, and the locations 15 are preferably high consumer traffic areas. The PDTs 20, for example, advantageously can be mounted on shelves, seats, racks, counters and other locations within the site such as in a line of site of a user. Each of the plurality of portable data terminals 20 is preferably networked through a data communication network or path 18, e.g., wireless, hard-wire, to a remote computer 40 having advertising software 45 stored in memory of or associated with the remote computer and defining an advertising server 40. The advertising server 40 advantageously allows selected product or service previews such as sneak previews of new movie releases, new or existing video game releases, new or existing sportswear, new or existing food products, new or existing beverages, new or existing equipment, and new or existing services, e.g., eye care, dental, medical, tax preparation services, or the like. The advertising server 40 allows controlled advertising on the network 18 to each of the plurality of portable data terminals 20 such as through the display 22 or other user interface by having the advertising software select, launch, and initiate the advertisements at all or selected ones of the plurality of PDTs 20.

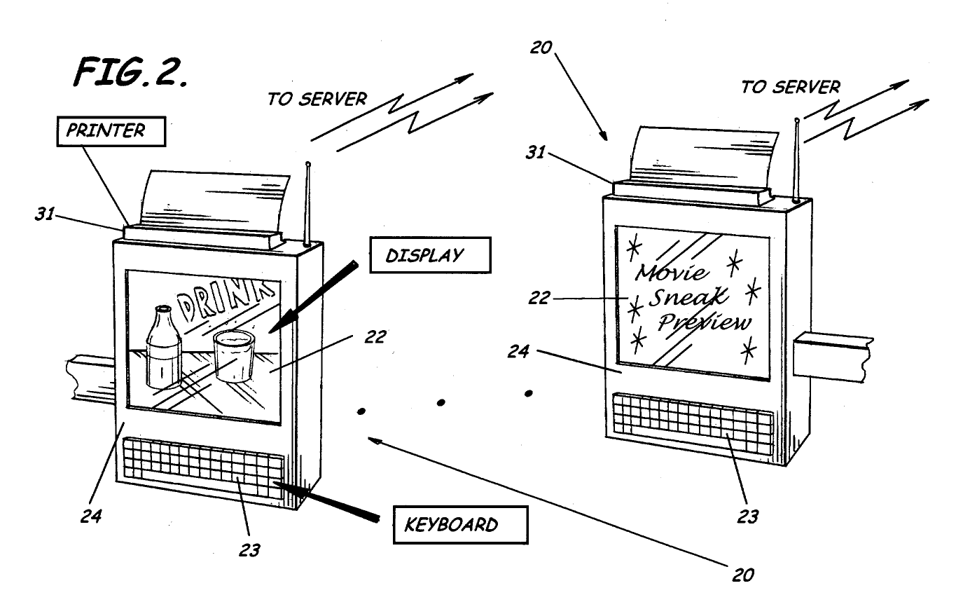

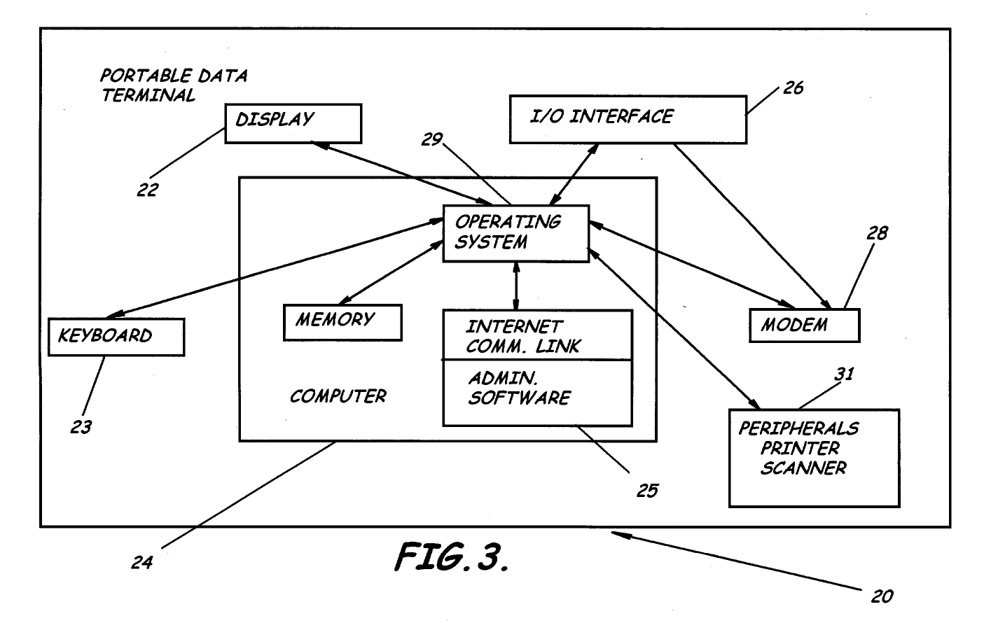

As perhaps best shown in FIGS. 2-3, the plurality of portable data terminals 20 each preferably include a flat panel display 22, e.g., a liquid crystal display, that is relatively small, e.g., about 18 inches, a portable computer 24 including a processor, as understood by those skilled in the art, in communication with the display 22 and including data communication input and output (I/O) interfaces 26, an operating system 27, e.g., LINUX, WINDOWS, stored on the processor, a modem 28 associated with the portable computer 24 for modulating and demodulating data communication to the portable computer 24, a communications link interface 32 to provide data communications to the data communications network 18, and administrative software 29 stored on the portable computer 24 to control the portable computer operations with the operating system 27, to provide reporting capabilities to the advertising server 40, and to control advertisement changes received from the advertising server 40. The system 10 also preferably has a communications network 18, e.g., a global communication network such as the Internet, associated with each of the plurality of portable data terminals 20 and the server 40 so that advertisement content can be transferred and updated wirelessly or in real time through a secured Internet access from the server 40 to each terminal 20. The terminals can also advantageously include a keyboard 23, a touch screen associated with the display 22 as understood by those skilled in the art, or other user interface device to provide user feedback to the server 40 through the portable data terminal 20.

The advertisements on each of the plurality of portable data terminals 20 can then advantageously be controlled by the advertising server 40 and allow advertisers to reach large audiences without the expense of a separate national advertising campaign. Advertisements using embodiments of the present invention can then be targeted for selected audiences during selected time periods chosen by the advertiser to have maximum impact. Also, an embodiment of a system of the present invention can advantageously reward user feedback on the advertisements or previews with gifts, coupons, or other incentives by the use of printer 31 or other peripherals associated with the PDTs 20 (see FIG. 2) to print or provide the rewards in some type of tangible medium, e.g., paper, plastic, magnetics, memory, or electronics.

Each of the plurality of portable data terminals 20 of the system 10 preferably operates as an advertising machine as a vehicle for companies that typically engage in a mass marketing product saturation to effectively hit consumers while they are on the go at various retail or service locations. The advertising machine 20 advantageously allows for a captive audience, which can be important when marketing a product or service. With prior art techniques or systems, consumer feedback is often very little or non-existing. If there is feedback, it is usually in a controlled setting. Embodiments of the present invention advantageously allow for true feedback as well as captivating consumers for a few moments of time and then providing rewards or incentives for users to provide feedback. The server 40 also advantageously has a website accessible by potential advertisers through one or more advertiser computers 50 having a processor 54 and a communications interface 59, as understood by those skilled in the art, located at an advertising company site to assist in launching advertisement through the network of portable data terminals 20. Also, each of the portable data terminals 20 can also be associated with one or more auxiliary user interfaces such as a barcode scanner, a magnetic swipe reader, a digital camera, a printer 31, a speaker, a keyboard, biometric scanner, e.g., fingerprint, retina, voice, shape of head, or other peripheral devices as understood by those skilled in the art. The present invention allows companies to advertise to millions of consumers fairly rapidly without waiting for them to turn on a television, read a magazine, or the like. Instead, the advertisements are brought to all the locations of high traffic areas of consumers rapidly and in a controlled manner.

Each of the portable data terminals 20 is preferably mounted in a customer visiting location 15 and positioned to be readily viewed by customers in these high traffic areas. Customers can then decide whether to participate in feedback sessions to receive gifts, free tickets, coupons, or the like. The system 10 and methods of embodiments of the present invention advantageously allow advertising companies to spread the word about their product quickly with greatly reduce expenditures and then provide feedback if desired. The feedback, for example, can be through touch screens, mouse, keyboards or other interface devices and can cooperate with a graphical user interface (GUI) or icon selection by the user as understood by those skilled in the art. The GUI, for example, can form a menu system that rewards consumer feedback with the coupons, gift certificates, or other rewards.

By having the PDTs 20 using a wireless interface such as an radio frequency wireless card data communications interface, as understood by those skilled in the art, the PDTs can be hand carried, mounted in various desired locations, and sold as groups to stores, stadiums, or other facilities for easy mounting and use. The stadiums, stores, and other facilities can have incentives in purchasing or leasing the items or can install free for a percentage of the advertising revenues. Alternatively, instead of a portable laptop computer, the PDTs 20, for example, can be custom mounting units or other custom designed devices such as shown in FIG. 2. Further, the PDTs can be carried by consumers if desired. The PDTs 20 are preferably dedicated advertising devices so that advantageously the expense of the devices can be reduced, so that custom advertising software can be downloaded to the devices, so that video, sound, and other features can be readily added or used with the PDTs, and so that different system designs can be accomplished for desired locations of the PDTs. Alternatively, the PDTs can be a part of an existing portable laptop computer, PDA, cellular phone, or other device as well.

In such a system 10, a portable computer, for example, can have a built in universal serial board (USB) interface, a hard drive, and serial and parallel ports. A ricochet wireless IP modem using USB connections can be used along with a Linux based operating system for stability, a web browser, a flash player, and software to control administration, reporting, and changes. Ad content can be transferred wirelessly through secured internet access into the portable computer devices to upload content. Ad changes can be accomplished the same way. The software for each device or PDT 20, for example, can be updated through the Internet based on manufacturer's code of each device as an identification. The PDTs 20 can automatically restart, for example, once uploading or changes have been completed. The PDTs 20 also advantageously can be responsive to the advertising server 20 to selectively turn on and turn off the PDTs for store, stadium, forum, or facility operating hours by stored program control from the server. In effect, the advertising server operator creates another custom advertising venue for advertisers to reach the consuming public and to provide feedback on the advertisements in near or actual real time (subject to the telecommunications data transfer delays), if desired.

As shown in FIGS. 1-3, and 5, the advertising server 40 has advertising software 45 associated therewith such as stored in memory of the computer or on a compact disc load onto the computer 40 to store in memory. The advertising software 45 includes an advertisement database 41 having a plurality of different advertisements 42 stored therein and an advertisement selector 43 positioned in communication with the advertisement database 41 to select at least one of the plurality of different advertisements 42 to be viewed on each of the displays 22 of the plurality of PDTs 20 by users thereof. The advertisements when displayed on the display 22 of the PDTs 20 to a user previewing advertisements, an advertisement data administrator 46 in communication with the advertisement controller 44 to administer preselected advertisement commands, such as provided by an advertiser or system operator, to the advertisement controller 44 for display to and interface with users previewing advertisements on the display 22 of the PDTs 20, and an advertisement reporter 47 in communication with the advertisement controller 44 to report advertisement data to an advertiser responsive to or based upon results obtained by advertisement previews of users. The system 10 can also include a plurality of auxiliary user interfaces, such as printers 31, dispensers, memory storage interfaces, or other interfaces as described above herein and as understood by those skilled in the art, which each are in communication with at least one of the PDTs 20 and in communication with the advertising server 40, e.g., through the PDT 20 or directly, to supply rewards to users responsive to feedback supplied from the users to the advertising server through the plurality of PDTs 20.

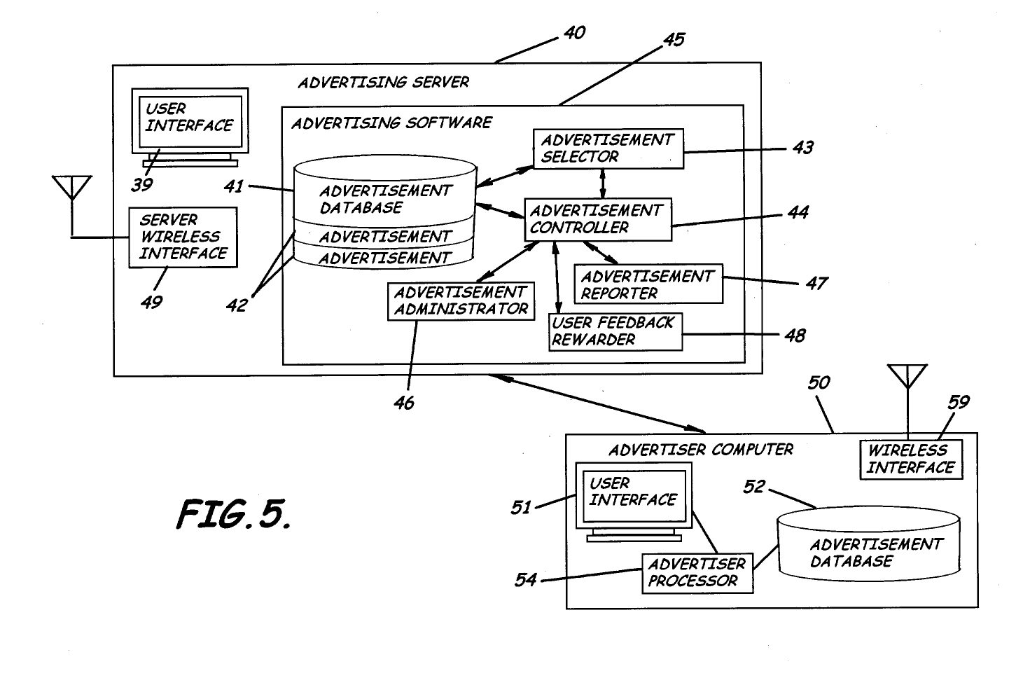

As shown in FIG. 5, the advertising software 45 can further include a user feedback rewarder 48 in communication with the advertising controller to provide at least one user feedback reward to each of the plurality of auxiliary user interfaces 31. The advertising server can also include an advertising administrator using interface 39, such as a display or graphical user interface (“GUI”), positioned to interface with an advertiser so that the advertiser administrator can view what a user can view on the remote displays 22 and a server wireless interface 49 positioned in communication with a global data communications network 18 or other network to provide wireless data communications from the advertising server 40 to each wierless data communication interface, e.g., radio frequency, microwave, satellite, infrared, of the PDTs 20 through the global data communication network 18.

Each of the plurality of advertising computers 50 can include an advertiser interface 51, e.g., a display or graphical user interface, positioned to interface with an advertiser, an advertisement database 52 having at least one and preferably a plurality of advertisements stored therein to be transmitted to the advertising server 40 through the network 18, an advertisement processor 54 for processing advertisements and an advertisement protocol generator 56 in communication with the advertisement processor to provide advertisement program commands, e.g., parameters of the advertisement such as time, how often or sizing, type of advertisement, and content of advertisement, to the advertising server 40 and being representative of advertising instructions.

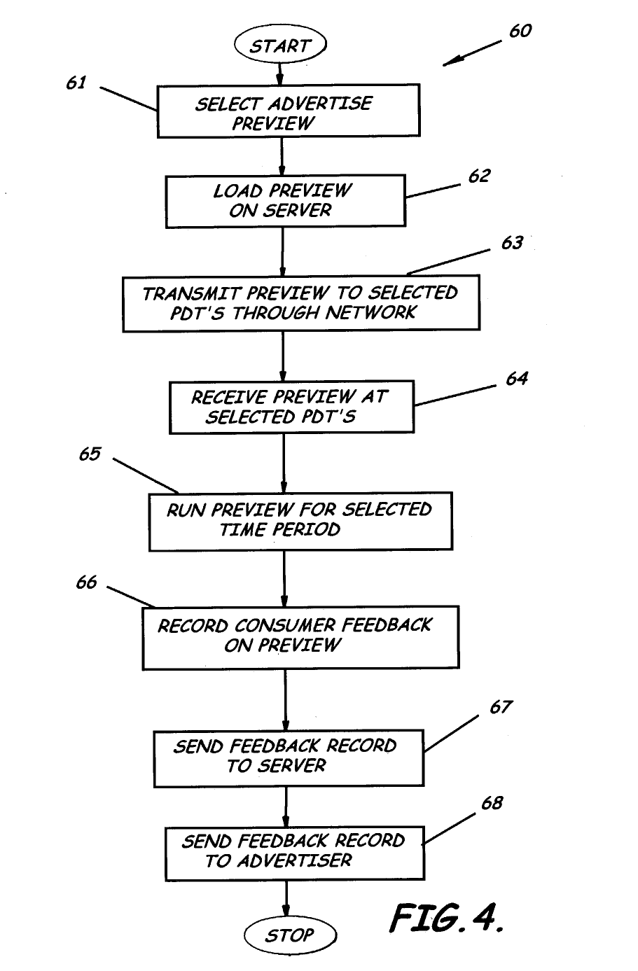

FIG. 4 illustrates an embodiment of a method 60 of advertising using the present invention. For example, an operator or advertiser selects an advertisement to be previewed 61 and this advertisement is loaded on the advertising server 40 from the server or advertising company 62. The advertisement is transmitted for preview to one or more of the PDTs 20 through the network 18 to users 63. The advertisement preview is received 64 and run for a preselected time period 65 such as based on the program commands. Consumer feedback is recorded on the preview 66, and the feedback is transmitted to the server 67. This feedback record can then be sent to the advertiser 68. By having an advertiser networked to the server 40, immediate or real time feedback can allow advertisers to more quickly adjust advertisements, product or service offerings, and reports on users patterns or other data.

As shown in FIGS. 1-5, and as described above, the present invention also includes methods of advertising to selected users and methods of doing business. A method of advertising to selected users, for example, includes providing a plurality of portable data terminals at a plurality of separate consumer site visiting locations. Each of the plurality of portable data terminals is positioned in communication with a data communications network and has a display associated therewith to display advertisements to be previewed by users thereof viewing the display. The method also includes providing a remote computer in communication with each of the plurality of portable data terminals through the data communications network and having memory and advertising software stored in the memory so that the remote computer having the advertising software stored in the memory defines an advertising server to allow selected advertisement previews on each display of the plurality of portable data terminals from the advertising server through the data communications network, selecting at least one of a plurality of different advertisements to be viewed on each of the displays of the plurality of portable data terminals by users thereof, and controlling the selected one of the plurality of advertisements by the advertising server when displayed on the display of the portable data terminals to a user previewing advertisements and responsive to a plurality of preselected commands of an advertiser.

The method can also include each of the plurality of data communication terminals being a portable computer, the display of each of the plurality of portable computers being a flat panel display, and each of the plurality of portable computers further having data communication input and output interfaces, an operating system, a modem to modulate and demodulate data communication to the portable computer, and administrative software stored on the portable computer to control the portable computer operations with the operating system to provide reporting capabilities and to control advertisement changes. The method can further include providing feedback on the selected advertisement to the advertisement server responsive to the user, wirelessly communicating from each of the plurality of portable data terminals to the data communications network, wirelessly communicating from the advertising server to the data communications network, and interfacing with an advertiser administrator so that the advertiser administrator can view what a user can view, administering preselected advertisement program commands of an advertiser to the advertising server for display to and interface with users previewing advertisements. The method can still further include remotely reporting advertisement data to an advertiser based on results obtained by advertisement previews of users, supplying rewards to users responsive to feedback supplied from the users to the advertising server through the plurality of portable data terminals, providing at least one user feedback reward to each of the plurality of portable data terminals, and printing a user reward on a tangible print medium for use by the users, and wherein the user reward comprises a reward associated with at least one advertisement viewed by the users. Also, the method can include providing a plurality of advertising computers each positioned remote from the advertising server at an advertising company site and in communication therewith through the data communications network. Each of the plurality of advertising computers, for example, can include an advertiser interface positioned to interface with an advertiser, an advertisement database having at least one advertisement stored thereon, and an advertisement protocol to provide advertisement program commands to the advertising server representative of advertisement instructions for displaying the at least one advertisement to users of the display of the plurality of portable data terminals. The method can further include transmitting the at least one advertisement to the advertising server through the data communications network and transmitting the advertisement program commands to the advertising server through the data communications network.

Another method of advertising includes selecting at least one of a plurality of different advertisements to be remotely viewed by users, remotely displaying the at least one of the plurality of different advertisements to a display of a plurality of portable data terminals, controlling the at least one of the plurality of different advertisements displayed remotely to the display of the plurality of portable data terminals to users previewing advertisements, administering preselected advertisement program commands of an advertiser for display to and interface with users when previewing advertisements on the display of each of the plurality of portable data terminals, and reporting advertisement data to an advertiser based on results obtained when previewing advertisements previews by the users. This method can also include storing the plurality of different advertisements remote from the plurality of portable data terminals, transmitting the at least one of the plurality of different advertisements to at least one of the plurality of portable data terminal, receiving user feedback from the at least one of the plurality of portable data terminals on the at least one of the plurality of different advertisements, providing at least one user feedback reward to a user of the at least one portable data terminal responsive to receiving user feedback, transmitting the preselected advertiser commands to the at least one portable data terminals, and storing advertisement reporting data responsive to user feedback prior to reporting to the advertiser.

A method of doing business, for example, includes selecting an advertisement of a product or service at a first location, transmitting the advertisement to a remote customer site of a second location through a global communications network, advertising the advertisement through to a user interface at a customer site location to a user, recording user feedback data on the advertisement from the user, and transmitting the user feedback data to the first location through the global communications network. Another method of doing business includes directly targeting customers of a selected advertisement previews from an advertising server through a plurality of portable data terminals positioned at a customer site location remote from the advertising server, running the selected advertisement preview for a preselected time period on the plurality of portable data terminals, receiving user feedback on the selected advertisement at the plurality of portable data terminals, and rewarding the user at the customer site location through the plurality of portable data terminal responsive to the user feedback.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as set forth in the following claims.

That claimed is:

1. A system for advertising through product or service previews, the system comprising:
a plurality of portable data terminals positioned at a plurality of separate consumer site visiting locations, each of the plurality of portable data terminals having a display associated therewith to display advertisements to be previewed by users thereof viewing the display;
a data communications network in communication with each of the plurality of portable data terminals;
a remote computer in communication with the data communications network and having memory and advertising software stored in the memory so that the remote computer having the advertising software stored in the memory defines an advertising server to allow selected advertisement previews on each display of the plurality of portable data terminals through the data communications network, the advertising software including an advertisement database having a plurality of different advertisements stored therein, an advertisement selector positioned in communication with the advertisement database to select at least one of the plurality of different advertisements to be viewed on each of the displays of the plurality of portable data terminals by users thereof, an advertisement controller in communication with the advertisement database and the advertisement selector to control selected advertisements when displayed on the display of the portable data terminals to a user previewing advertisements, an advertisement data administrator in communication with the advertisement controller to administer preselected advertisement program commands to the advertisement controller for display to and interface with users previewing advertisements on the display of each of the plurality of portable data terminals, and an advertisement reporter in communication with the advertisement controller to report advertisement data to an advertiser responsive to results obtained by advertisement previews of users; and
a plurality of auxiliary user interfaces each in communication with at least one of the plurality of portable data terminals and in communication with the advertising server to supply rewards to users responsive to feedback supplied from the users to the advertising server through the plurality of portable data terminals.

2. A system as defined in claim 1, wherein each of the plurality of data communication terminals comprises a portable computer, wherein the display of each of the plurality of portable computers comprises a flat panel display, and wherein each of the plurality of portable computers further comprises data communication input and output interfaces, an operating system, a modem to modulate and demodulate data communication to the portable computer, and administrative software stored on the portable computer to control the portable computer operations with the operating system to provide reporting capabilities and to control advertisement changes.

3. A system as defined in claim 2, wherein the flat panel display includes a touch screen user interface responsive to the touch of a user to allow the user to provide feedback to the advertisement server in response to touched selections by the user.

4. A system as defined in claim 3, wherein the data communications network comprises a global data communications network, wherein the advertising server further includes security protocol software stored thereon, wherein each of the plurality of portable data terminals comprises a wireless data communication interface positioned to provide wireless data communication to the global data communications network, and the system further comprises a server wireless interface positioned in communication with the global data communications network to provide wireless data communications from the advertising server to each wireless data communication interface of the plurality of data communication terminals through the global data communications network.

5. A system as defined in claim 4, wherein the advertising server includes an advertising administrator user interface positioned to interface with an advertiser administrator so that the advertiser administrator can view what a user can view.

6. A system as defined in claim 5, wherein the advertising software further includes a user feedback rewarder in communication with the advertising controller to provide at least one user feedback reward to each of the plurality of auxiliary user interfaces, and wherein each of the plurality of auxiliary user interfaces comprises a printer positioned to print a user reward on a tangible print medium for use by the users, and wherein the user reward comprises a reward associated with at least one advertisement viewed by the users.

7. A system as defined in claim 6, further comprising a plurality of advertising computers each positioned remote from the advertising server at an advertising company site and in communication therewith through the global data communications network, each of the plurality of advertising computers including an advertiser interface positioned to interface with an advertiser, an advertisement database having at least one advertisement stored thereon to be transmitted to the advertising server through the global data communications network, and an advertisement protocol to provide advertisement program commands to the advertising server representative of advertisement instructions for displaying the at least one advertisement to users of the display of the plurality of portable computers.

8. A system for advertising through product or service previews, the system comprising:
a plurality of portable data terminals positioned at a plurality of separate consumer site visiting locations, each of the plurality of portable data terminals having a display associated therewith to display advertisements to be previewed by users thereof viewing the display;
a data communications network in communication with each of the plurality of portable data terminals; and
a remote computer in communication with the data communications network and having memory and advertising software stored in the memory so that the remote computer having the advertising software stored in the memory defines an advertising server to allow selected advertisement previews on each display of the plurality of portable data terminals through the data communications network, the advertising software including an advertisement database having a plurality of different advertisements stored therein, an advertisement selector positioned in communication with the advertisement database to select at least one of the plurality of different advertisements to be viewed on each of the displays of the plurality of portable data terminals by users thereof, and an advertisement controller in communication with the advertisement database and the advertisement selector to control selected advertisements when displayed on the display of the portable data terminals to a user previewing advertisements.

9. A system as defined in claim 8, wherein each of the plurality of data communication terminals comprises a portable computer, wherein the display of each of the plurality of portable computers comprises a flat panel display, and wherein each of the plurality of portable computers further comprises data communication input and output interfaces, an operating system, a modem to modulate and demodulate data communication to the portable computer, and administrative software stored on the portable computer to control the portable computer operations with the operating system to provide reporting capabilities and to control advertisement changes.

10. A system as defined in claim 9, wherein the flat panel display includes a touch screen user interface responsive to the touch of a user to allow the user to provide feedback to the advertisement server in response to touched selections by the user.

11. A system as defined in claim 8, wherein the data communications network comprises a global data communications network, wherein the advertising server further includes security protocol software stored thereon, wherein each of the plurality of portable data terminals comprises a wireless data communication interface positioned to provide wireless data communication to the global data communications network, and the system further comprises a server wireless interface positioned in communication with the global data communications network to provide wireless data communications from the advertising server to each wireless data communication interface of the plurality of data communication terminals through the global data communications network.

12. A system as defined in claim 8, wherein the advertising server includes an advertising administrator user interface positioned to interface with an advertiser administrator so that the advertiser administrator can view what a user can view, and wherein the advertising software further includes an advertisement data administrator in communication with the advertisement controller to administer preselected advertisement program commands of an advertiser to the advertisement controller for display to and interface with users previewing advertisements, and an advertisement reporter in communication with the advertisement controller to report advertisement data to an advertiser based on results obtained by advertisement previews of users.

13. A system as defined in claim 8, further comprising a plurality of auxiliary user interfaces each in communication with at least one of the plurality of portable data terminals and in communication with the advertising server to supply rewards to users responsive to feedback supplied from the users to the advertising server through the plurality of portable data terminals.

14. A system as defined in claim 13, wherein the advertising software further includes a user feedback rewarder in communication with the advertising controller to provide at least one user feedback reward to each of the plurality of auxiliary user interfaces, and wherein each of the plurality of auxiliary user interfaces comprises a printer positioned to print a user reward on a tangible print medium for use by the users, and wherein the user reward comprises a reward associated with at least one advertisement viewed by the users.

15. A system as defined in claim 8, further comprising a plurality of advertising computers each positioned remote from the advertising server at an advertising company site and in communication therewith through the data communications network, each of the plurality of advertising computers including an advertiser interface positioned to interface with an advertiser, an advertisement database having at least one advertisement stored thereon to be transmitted to the advertising server through the global data communications network, and an advertisement protocol to provide advertisement program commands to the advertising server representative of advertisement instructions for displaying the at least one advertisement to users of the display of the plurality of portable data terminals.

16. Advertising software stored on a storage medium, the software comprising:
an advertisement selector positioned to select at least one of a plurality of different advertisements to be remotely viewed by users when displayed remotely to a display of a plurality of portable data terminals;
an advertisement controller in communication with the advertisement selector to control each of the plurality of different advertisements selected by the advertising selector when displayed remotely to a display of a plurality of portable data terminals to users previewing advertisements;
an advertisement data administrator in communication with the advertisement controller to administer preselected advertisement program commands of an advertiser to the advertisement controller for display to and interface with users when previewing advertisements on the display of each of the plurality of portable data terminals; and
an advertisement reporter in communication with the advertisement controller to report advertisement data to an advertiser based on results obtained when previewing advertisements previews by users.

17. Software as defined in claim 16, further comprising an advertisement database positioned in communication with the advertising selector having the plurality of different advertisements stored therein.

18. Software as defined in claim 17, further comprising a user feedback rewarder in communication with the advertising controller to provide at least one user feedback reward to users.

19. A method of advertising to selected users, the method comprising:
providing a plurality of portable data terminals at a plurality of separate consumer site visiting locations, each of the plurality of portable data terminals being positioned in communication with a data communications network and having a display associated therewith to display advertisements to be previewed by users thereof viewing the display;
providing a remote computer in communication with each of the plurality of portable data terminals through the data communications network and having memory and advertising software stored in the memory so that the remote computer having the advertising software stored in the memory defines an advertising server to allow selected advertisement previews on each display of the plurality of portable data terminals from the advertising server through the data communications network;
selecting at least one of a plurality of different advertisements to be viewed on each of the displays of the plurality of portable data terminals by users thereof; and
controlling the selected one of the plurality of advertisements by the advertising server when displayed on the display of the portable data terminals to a user previewing advertisements and responsive to a plurality of preselected commands of an advertiser.

20. A method defined in claim 19, wherein each of the plurality of data communication terminals comprises a portable computer, wherein the display of each of the plurality of portable computers comprises a flat panel display, and wherein each of the plurality of portable computers further comprises data communication input and output interfaces, an operating system, a modem to modulate and demodulate data communication to the portable computer, and administrative software stored on the portable computer to control the portable computer operations with the operating system to provide reporting capabilities and to control advertisement changes.

21. A method as defined in claim 19, further comprising providing feedback on the selected advertisement to the advertisement server responsive to the user.

22. A method as defined in claim 19, wirelessly communicating from each of the plurality of portable data terminals to the data communications network and wirelessly communicating from the advertising server to the data communications network.

23. A method as defined in claim 19, further comprising interfacing with an advertiser administrator so that the advertiser administrator can view what a user can view, administering preselected advertisement program commands of an advertiser to the advertising server for display to and interface with users previewing advertisements, and remotely reporting advertisement data to an advertiser based on results obtained by advertisement previews of users.

24. A method as defined in claim 23, further comprising supplying rewards to users responsive to feedback supplied from the users to the advertising server through the plurality of portable data terminals.

25. A method as defined in claim 19, further comprising providing at least one user feedback reward to each of the plurality of portable data terminals, and printing a user reward on a tangible print medium for use by the users, and wherein the user reward comprises a reward associated with at least one advertisement viewed by the users.

26. A method as defined in claim 19, further comprising providing a plurality of advertising computers each positioned remote from the advertising server at an advertising company site and in communication therewith through the data communications network, each of the plurality of advertising computers including an advertiser interface positioned to interface with an advertiser, an advertisement database having at least one advertisement stored thereon, and an advertisement protocol to provide advertisement program commands to the advertising server representative of advertisement instructions for displaying the at least one advertisement to users of the display of the plurality of portable data terminals, and the method further comprising transmitting the at least one advertisement to the advertising server through the data communications network and transmitting the advertisement program commands to the advertising server through the data communications network.

27. A method of advertising, the method comprising:
selecting at least one of a plurality of different advertisements to be remotely viewed by users;
remotely displaying the at least one of the plurality of different advertisements to a display of a plurality of portable data terminals;
controlling the at least one of the plurality of different advertisements displayed remotely to the display of the plurality of portable data terminals to users previewing advertisements;
administering preselected advertisement program commands of an advertiser for display to and interface with users when previewing advertisements on the display of each of the plurality of portable data terminals; and
reporting advertisement data to an advertiser based on results obtained when previewing advertisements previews by the users.

28. A method as defined in claim 27, further comprising storing the plurality of different advertisements remote from the plurality of portable data terminals, transmitting the at least one of the plurality of different advertisements to at least one of the plurality of portable data terminal and receiving user feedback from the at least one of the plurality of portable data terminals on the at least one of the plurality of different advertisements.

29. A method as defined in claim 28, further comprising providing at least one user feedback reward to a user of the at least one portable data terminal responsive to receiving user feedback.

30. A method as defined in claim 29, further comprising transmitting the preselected advertiser commands to the at least one portable data terminals, and storing advertisement reporting data responsive to user feedback prior to reporting to the advertiser.

31. A method of doing business, the method comprising:
selecting an advertisement of a product or service at a first location;
transmitting the advertisement to a remote customer site of a second location through a global communications network;
advertising the advertisement through to a user interface at a customer site location to a user;
recording user feedback data on the advertisement from the user; and
transmitting the user feedback data to the first location through the global communications network.

32. A method of doing business, the method comprising:
directly targeting customers of a selected advertisement previews from an advertising server through a plurality of portable data terminals positioned at a customer site location remote from the advertising server;
running the selected advertisement preview for a preselected time period on the plurality of portable data terminals;
receiving user feedback on the selected advertisement at the plurality of portable data terminals; and
rewarding the user at the customer site location through the plurality of portable data terminal responsive to the user feedback.
